(19) United States
(12) Patent Application Publication
(10) Pub. No.: US 2020/0262212 A1
(43) Pub. Date: Aug. 20, 2020

(54) METHOD AND DEVICE FOR DEGASSING WATER-BASED INK, AND PRINTING MACHINE

(71) Applicant: HEIDELBERGER DRUCKMASCHIENEN AG, Heidelberg (DE)

(72) Inventor: JOERG-ACHIM FISCHER, Laboe (DE)

(21) Appl. No.: 16/722,799

(22) Filed: Dec. 20, 2019

(30) Foreign Application Priority Data
Feb. 14, 2019 (DE) 102019201969

(51) Int. Cl. B41J 2/19

(52) U.S. Cl. CPC B41J 2/19

(57) ABSTRACT

A method for degassing water-based ink is described. An ink reservoir is connected to a vacuum source via a gas-permeable membrane and a connecting piece to remove the undesired gas. During the degassing process, water vapor is fed to the connecting piece. Thus, the viscosity of the water-based ink in the ink reservoir remains on an essentially constant level. The method may advantageously be implemented continuously in inkjet printing machines.

### CROSS-REFERENCE TO RELATED APPLICATION

This application claims the priority, under 35 U.S.C. § 119, of German patent application DE 10 2019 201 969, filed Feb. 14, 2019; the prior application is herewith incorporated by reference in its entirety.

### BACKGROUND OF THE INVENTION

### Field of the Invention

The present invention relates to a method for degassing water-based ink, to a device for degassing water-based ink, and to the use of such a device in a printing machine, in particular in an inkjet printing machine.

Inkjet printing machines generally have one or more inkjet printing heads that apply water-based ink to the printing substrate. An undesired phenomenon in this context is that the water-based inks that are used contain gases, in particular air. When the image is created on the printing substrate, this may cause problems; in particular, defective prints may be the result.

To reduce these problems, methods of degassing water-based inks before they are used in the inkjet printing operation have become known. Since ink that has been degassed may absorb gases again, the degassing process generally needs to be repeated multiple times, for instance after longer periods during which the printing machine is at a standstill. It has in principle become known to degas inks with the aid of a membrane that allows gas to pass through. In that process, a vacuum is applied to the membrane, which is in contact with the water-based ink, to remove the gas through the membrane, thus reducing the undesired gas content of the water-based ink.

United States patent application US 2013/0083099 A1 discloses a degassing device for inkjet ink wherein the gas that is dissolved in the ink is removed through a membrane by means of a pump.

The degassing methods using membranes that allow gas to pass through as described in the prior art have disadvantages. Along with the dissolved gas, the process also removes water in the form of vapor through the membrane that allows gas to pass through. This results in reduced water content in the water-based ink and consequently the viscosity of the ink increases—an aspect that may have undesired effects during the printing operation. If the ink loses too much water, it cannot be applied any more at all. A common prior art approach to alleviating this problem is to apply only a weak vacuum and to maintain it only for a short period of time.

### SUMMARY OF THE INVENTION

It is accordingly an object of the invention to provide a method and a device for degassing water-based ink by means of a membrane, which overcome the above-mentioned and other disadvantages of the heretofore-known devices and methods of this general type and which provides for degassing with a membrane that allows gas to pass through and to alleviate the problem of undesired viscosity increases, thus allowing the water-based ink to be applied without any problem. The method is intended to provide effective degassing. The method is intended to be usable even in ink supply systems that are not gas-tight. The method is intended to be continuously applicable without difficulty.

With the above and other objects in view there is provided, in accordance with the invention, a method of degassing water-based ink, the method comprising:

providing an ink reservoir with water-based ink, the ink reservoir being connected to at least one vacuum source via a membrane configured to allow gas to pass through and at least one connecting piece;

generating a vacuum with the at least one vacuum source to remove gas dissolved in the water-based ink through the membrane and via the at least one connecting piece; and

feeding water vapor from a source of water-vapor to the at least one connecting piece in order to maintain a viscosity of the water-based ink in the ink reservoir at a substantially constant level.

Surprisingly, it has been found that an easy way to efficiently degas ink while maintaining the viscosity thereof at a constant level is to feed water vapor to the removed gas during the degassing process. In the preferred embodiment of the method, a balance is created between the water vapor that is removed from the ink and the water vapor that is supplied to the removed gas.

The method of the invention may advantageously be used in non-gas-tight ink supply systems and may be used continuously over long uninterrupted periods of time without any undesired ink viscosity increase. If the method is applied continuously, the start-up time of the printing machine is advantageously reduced because a longer interruption of the printing operation no longer always requires a degassing process as it is the case in the prior art. In the method of the invention, comparatively low absolute pressures may be set in the degassing process to ensure effective degassing without simultaneously increasing the viscosity of the water-based ink in an undesired way.

Accordingly, the present invention relates to a method for degassing water-based ink comprising the steps of providing an ink reservoir containing water-based ink, said ink reservoir connected to at least one vacuum source via a membrane that allows gas to pass through and at least one connecting piece and, by means of said vacuum source, generating a vacuum to at least partially remove the gas dissolved in the water-based ink through the membrane that allows gas to pass through and via the at least one connecting piece, providing at least one source of water vapor, and supplying water vapor to the at least one connecting piece to ensure that the viscosity of the water-based ink in the ink reservoir remains on an essentially constant level.

In a preferred embodiment, the at least one source of water vapor is a heatable water reservoir. In this case, the heatable water reservoir includes at least one heating device, preferably an electric heating device. In general, such a heatable water reservoir additionally includes a temperature measurement device and a control unit for setting a desired temperature of the water in the water reservoir. In addition, the water reservoir may be connected to a water tank for refilling the heatable water reservoir with water.

In accordance with the method of the invention, an ink reservoir is provided. The ink reservoir is connected to at least one vacuum source via a membrane that allows gas to pass through and via at least one connecting piece.

The ink reservoir that is used in the context of the present invention is preferably a container with two chambers separated by a membrane that allows gas to pass through. One of the two chambers is filled with the water-based ink and preferably has a connecting line to the inkjet printing head. The at least one connecting piece connects the other one of the two chambers to the at least one vacuum source.

In principle, all membranes known in the art for degassing ink are suitable for use as the membrane that allows gas to pass through. In general, they are liquid-tight, in particular watertight, and allow gases, in particular water vapor and air, to pass through in both directions.

The at least one connecting piece is preferably a tube or hose made of a material that is impermeable to water vapor, for instance a plastic or rubber hose. The at least one connecting element may comprise a chamber to increase the volume between the ink reservoir and the at least one vacuum source.

In accordance with a preferred feature of the invention, the at least one vacuum source is a pump.

In a further preferred embodiment, the at least one connecting piece is a tube or hose, for instance a plastic or rubber hose, and the at least one vacuum source is a pump.

In the context of the present invention, water-based ink is understood to refer to inks, in particular inks that are suitable for inkjet printing, that have a water content of at least 10% by weight (wt %), in particular at least 20 wt %, relative to the total weight of the water-based ink. The water content of such inks usually ranges between 30 and 90 wt %, preferably between 40 and 80 wt %, in particular between 50 and 70 wt % relative to the total weight of the water-based ink.

In the method of the invention, water-based inks of different viscosities may be used. The viscosity of the water-based ink preferably ranges between 1 and 30 mPa·s, in particular between 2 and 15 mPa·s, especially between 30 to 10 mPa·s, measured at 30° C. using a cone and plate viscometer.

In the process according to the invention, the viscosity of the water-based ink remains substantially constant during the degassing process. This means that during the degassing process, the viscosity changes by less than 30%, in particular less than 20%, and especially by less than 10% relative to the viscosity it had before the beginning of the degassing process.

The temperature of the water-based ink in the ink reservoir during the degassing process preferably ranges between 20 and 40° C., in particular between 25 and 35° C.

In accordance with the method of the invention, the at least one vacuum source is used to set a lower pressure at the membrane that allows gas to pass through and at the at least one connecting piece. The absolute pressure at the membrane and in the at least one connecting piece lies between 50 and 150 mbar (5000-15000 Pa), in particular between 70 and 130 mbar (7000-13000 Pa). The most preferred range is 80 to 120 mbar (8000-12000 Pa).

In accordance with the method of the invention, water vapor from at least one water vapor source is fed to the at least one connecting piece.

In a preferred embodiment, a flow of water vapor is fed from the at least one water vapor source to the at least one connecting piece in such a way that a balance is established between the water vapor that reaches the at least one connecting piece from the ink reservoir through the membrane and the water vapor that reaches the ink reservoir from the at least one connecting piece through the membrane. In this embodiment, the partial pressure of the water vapor at the membrane that allows gas to pass through equals the partial pressure of the water vapor in the at least one connecting piece.

In a preferred embodiment, the supply of water vapor from the at least one water vapor source to the at least one connecting piece is controlled by measuring the water vapor pressure differential between the measured value at the membrane that allows gas to pass through and the measured value in the at least one connecting piece. In a preferred embodiment, the pressure differential is measured by electronic sensors such as capacitive water vapor sensors.

Further preferred measuring processes to control the feeding of the water vapor into the at least one connecting piece are based on measuring the viscosity of in the water-based ink in the ink reservoir, measuring the volume change of the water-based ink in the ink reservoir, and measuring the total volume of liquid water in the degassing device.

With the above and other objects in view there is also provided, in accordance with the invention, a device for degassing water-based inks, the device comprising:

an ink reservoir connected to at least one vacuum source via a membrane that allows gas to pass through and at least one connecting piece; and

at least one source of water vapor for feeding water vapor to the at least one connecting piece.

In other words, a device for implementing the method of the invention is likewise an object of the present invention. The device for degassing water-based ink comprises an ink reservoir connected to at least one vacuum source via a membrane that allows gas to pass through and via at least one connecting piece, and a source of water vapor from which water vapor may be fed to the at least one connecting piece. The ink reservoir, the water vapor-permeable membrane, the at least one vacuum source, and the at least one source of water vapor may be implemented as mentioned in the above description of the preferred elements in the context the method of the invention.

With the above and other objects in view there is also provided, in accordance with the invention, a printing machine, in particular an inkjet printing machine. Therefore the present invention also relates to the use of a device for degassing water-based ink in a printing machine, in particular an inkjet printing machine. The printing machine thus includes a device with an ink reservoir connected to at least one vacuum source via a gas-permeable membrane and via a connecting piece, and at least one source of water vapor for feeding water vapor into the at least one connecting piece.

The method of the invention allows water-based ink to be degassed without any undesired viscosity changes. The degassing process may advantageously be carried out at comparatively low pressures.

Other features which are considered as characteristic for the invention are set forth in the appended claims.

Although the invention is illustrated and described herein as embodied in a method and device for degassing water-based ink, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic representation of a degassing device according to the invention; and

FIG. 2 is a schematic illustration of a preferred embodiment of the degassing method using electric water vapor sensors and their electric resistors.

### DETAILED DESCRIPTION OF THE INVENTION

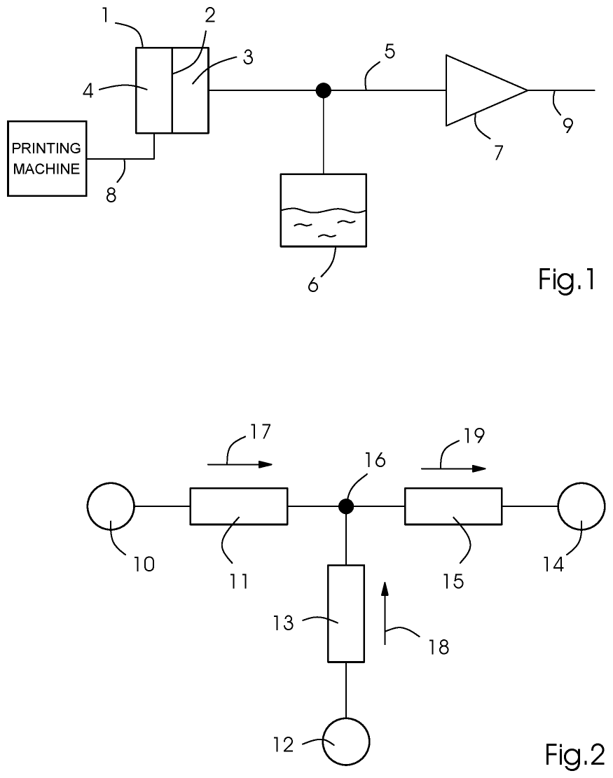

Referring now to the figures of the drawing in detail and first, particularly, to FIG. 1 thereof, there is shown an ink reservoir 1 with a membrane 2 that allows gas to pass through. The ink reservoir 1 has two chambers 3 and 4, separated by the membrane 2. The membrane 2 is a gas-permeable membrane that is specifically configured to allow water vapor to pass through. One of the chambers, chamber 4 in the illustration, is filled with water-based ink, and is connected via a line 8 to the inkjet printing head of an inkjet printing machine. A hose 5 connects the ink reservoir 1 with a heatable water reservoir 6 and a vacuum pump 7 with an exhaust hose 9.

With reference to FIG. 2, a water vapor flow 17 removes water vapor from the water-based ink 10 in the direction of the vacuum source 14. The water content of the water vapor flow 17 is measured using an electric water vapor sensor with a resistor 11. A water vapor flow 18 emanates from a water vapor source 12 and flows in the direction of the vacuum source 14. The water content of the water vapor flow 18 is measured using an electric water vapor sensor with a resistor 13. At the intersection 16, the flows of water vapor 17 and 18 meet to form a resultant flow of water vapor flow 19 that is measured by an electric water vapor sensor with a resistor 15. In this preferred embodiment, the resistance values 11 and 15 are preferably identical and remain constant in the course of the degassing process.

The following is a list of reference numerals used in the above description of the invention with reference to the drawing figures:
1 ink reservoir
2 gas-permeable membrane
3 chamber
4 chamber filled with water-based ink
5 hose
6 heatable water reservoir
7 vacuum pump
8 line
9 exhaust hose
10 water-based ink
11 resistor of the water vapor flow from the ink
12 water vapor source
13 resistor of the water vapor flow from the water vapor source
14 vacuum source
15 resistor of the resultant water vapor flow from ink and water vapor source
16 intersection
17 water vapor flow from the ink
18 water vapor flow from the water vapor source
19 resultant water vapor flow from ink and water vapor source

1. A method of degassing water-based ink, the method comprising:
providing an ink reservoir with water-based ink, the ink reservoir being connected to at least one vacuum source via a gas-permeable membrane and at least one connecting piece;
generating a vacuum with the at least one vacuum source to remove gas dissolved in the water-based ink through the membrane and via the at least one connecting piece; and
feeding water vapor from a source of water-vapor to the at least one connecting piece in order to maintain a viscosity of the water-based ink in the ink reservoir at a substantially constant level.

2. The method according to claim 1, wherein the at least one source of water vapor is a heatable water reservoir.

3. The method according to claim 1, wherein the at least one connecting piece is a hose and the at least one vacuum source is a pump.

4. The method according to claim 1, which comprises maintaining the viscosity of the water-based ink in the ink reservoir within a range from 1 to 30 mPa·s, measured at 30° C. using a cone plate viscometer.

5. The method according to claim 1, which comprises setting a partial pressure of the water vapor at the membrane to equal a partial pressure of the water vapor in the at least one connecting piece.

6. The method according to claim 1, which comprises setting the pressure at the membrane to a range between 50 and 150 mbar.

7. The method according to claim 1, which comprises controlling the feeding of water vapor by measuring a water vapor pressure differential between the membrane that allows gas to pass through and the at least one vacuum source.

8. The method according to claim 7, which comprises measuring the water vapor pressure differential by way of capacitive water vapor sensors.

9. A device for degassing water-based inks, the device comprising:
an ink reservoir connected to at least one vacuum source via a membrane that allows gas to pass through and at least one connecting piece; and
at least one source of water vapor for feeding water vapor to the at least one connecting piece.

10. A printing machine, comprising a device according to claim 9.
